(19) United States
(12) Patent Application Publication
(10) Pub. No.: US 2024/0245129 A1
(43) Pub. Date: Jul. 25, 2024

(54) ATOMIZING CORE AND ATOMIZING DEVICE

(71) Applicant: SHENZHEN GEEKVAPE TECHNOLOGY CO., LTD., Shenzhen (CN)

(72) Inventor: Shengwei ZHANG, Shenzhen (CN)

(73) Assignee: SHENZHEN GEEKVAPE TECHNOLOGY CO., LTD., Shenzhen (CN)

(21) Appl. No.: 18/624,096

(22) Filed: Apr. 1, 2024

Related U.S. Application Data
(63) Continuation of application No. PCT/CN2023/071133, filed on Jan. 7, 2023.

(51) Int. Cl. A24F 40/48; A24F 40/10; A24F 40/44; A24F 40/46; H05B 3/06

(52) U.S. Cl. CPC A24F 40/48; A24F 40/10; A24F 40/44; A24F 40/46; H05B 3/06; H05B 2203/007; H05B 2203/016; H05B 2203/021

(57) ABSTRACT

The present embodiment discloses an atomizing core, including an atomizing base and a heating member. The atomizing base is configured to be in contact with an atomizing medium. The atomizing base has an atomizing passage inside, and an air inlet and an air outlet of the atomizing passage are respectively in communication with two end faces of the atomizing base. The cross section of the atomizing passage perpendicular to the extending direction thereof has at least two shapes. The heating member is disposed in the atomizing passage and is arranged in a circumferential direction of the atomizing passage. The heating member at least covers more than half of the atomizing passage in the circumferential direction.

### CROSS-REFERENCE TO RELATED APPLICATION

The present application is a continuation of International Application No. PCT/CN2023/071133, filed on Jan. 7, 2023. The entire content of the above-identified application is expressly incorporated herein by reference.

### TECHNICAL FIELD

This application relates to the field of atomizing technologies, and in particular, to an atomizing core and an atomizing device having the atomizing core.

### TECHNICAL BACKGROUND

An atomizing device is also referred to as an electronic atomizing device, an electronic atomizer, etc., and an existing atomizing device can atomize, by means of heating, an internally stored fluid medium into an aerosol that can be inhaled by a user.

Specifically, the atomizing device generally includes a power-supply part and an atomizing part, where the power-supply part is used for supplying power to the atomizing part such that the atomizing part can work. The atomizing part is provided with a liquid storage cavity and an air channel separated from each other. An atomizing core is mounted in the air channel. The atomizing core is in fluid contact with an atomized liquid in the liquid storage cavity. The atomizing core is a core part of an electronic atomizing device. When powered on, the atomizing core can heat an atomizing medium into an aerosol that can be inhaled by a user.

Currently, there are mainly two types of atomizing cores in the market. One type of atomizing core is of a columnar structure, as shown in FIG. 1. Inside the atomizing core, an atomizing passage extends in an axial direction thereof and has a uniform inner diameter, and heating wires are spirally arranged on an inner wall of the atomizing passage. The heating wires are used to provide heat required for atomizing. A spring heating wire of the cylindrical ceramic atomizing core has a small diameter and is prone to coiling and deformation during production. Furthermore, the degree to which the spring heating wire of the cylindrical ceramic atomizing core exceeds the ceramic heating surface is unstable and is prone to being lower or higher than the ceramic heating surface, which results in a small atomizing amount or a smell of burning. Furthermore, the cylindrical ceramic atomizing core is cylindrical in both interior and exterior, and the cylindrical porous ceramic has a uniform wall thickness, but the thickness of the wall at the position directly facing the atomized liquid hole is small, which easily causes accumulation and leakage of the atomized liquid. Additionally, due to the surface tension of the atomized liquid, the center circular atomizing passage is prone to be blocked due to accumulation and leakage of atomized liquid.

Another type of atomizing core is a planar ceramic atomizing core based on a planar porous ceramic and a metal heating wire, as shown in FIG. 2. When using the planar ceramic atomizing core, an air channel must be designed as a deflected air channel, and condensate in the air channel tends to accumulate and block. Furthermore, the planar ceramic atomizing core directly introduces the atomized liquid towards the back side of the porous ceramic, when the atomized liquid is sticky, bubbles are difficult to rise and can easily block the atomized-liquid flowing channel, causing the atomized liquid to flow unsmoothly and thus resulting in dry burning as well as a smell of burning. The manufacturing cost of the planar ceramic atomizing core is relatively high.

In conclusion, it is desirable to provide an atomizing core and an atomizing device, which can solve the problem that the existing atomizing core is prone to splashing of atomizing medium and cannot work due to easy accumulation in the atomizing passage and blockage caused by leaked atomized-liquid and the problem of generation of a smell of burning due to blockage of atomized-liquid flowing channels.

### SUMMARY

In order to solve the described technical problem, the disclosure provides an atomizing core.

The atomizing core includes an atomizing base and a heating member.

The atomizing base is for being in contact with an atomizing medium. The atomizing base has an atomizing passage inside, an air inlet and an air outlet of the atomizing passage are respectively in communication with two end faces of the atomizing base, and a cross section of the atomizing passage perpendicular to an extending direction of the atomizing passage has at least two shapes.

The heating member is disposed in the atomizing passage. The heating member is arranged in a circumferential direction of the atomizing passage, and at least covers more than ½ of the atomizing passage in the circumferential direction.

Further, the atomizing passage includes, along an airflow inhalation direction, a first atomizing passage and a second atomizing passage, and an area of a cross section of the second atomizing passage perpendicular to an extending direction of the second atomizing passage is smaller than an area of a cross section of the first atomizing passage perpendicular to the extending direction the first atomizing passage.

Further, the cross section of the first atomizing passage perpendicular to the extending direction of the first atomizing passage is square, and the cross section of the second atomizing passage perpendicular to the extending direction of the second atomizing passage is any one of circle, ellipse, race-track shaped, and rectangle.

Further, along the airflow inhalation direction, the area of the cross section of the second atomizing passage perpendicular to the extending direction of the second atomizing passage gradually decreases.

Further, an inner wall of the first atomizing passage is an atomizing surface, a circumferential surface of the atomizing base is a liquid-absorbing surface. A distance from the liquid-absorbing surface to the atomizing surface is a wall thickness of the atomizing base, and the wall thickness of the atomizing base is at least partially unequal.

Further, an end-face portion of an air inlet of the second atomizing passage covers an air outlet of the first atomizing passage.

Further, the heating member is disposed in the first atomizing passage, the first atomizing passage includes four inner walls arranged in sequence and perpendicular to one another, and the heating member at least covers three inner walls of the first atomizing passage.

Further, multiple liquid inlet channels are arranged on the liquid-absorbing surface, and a liquid inlet direction of each of the liquid inlet channels is perpendicular to the inner wall of the first atomizing channel.

Further, the heating member includes two electrode pins, and the two electrode pins are disposed on two opposite inner walls of the first atomizing passage.

Further, the heating member includes multiple heating units connected in series, and each of the heating units is provided with a fixing portion which is attached and parallel to an inner wall of the atomizing passage and extends along the atomizing base.

The disclosure also provides an atomizing device. The atomizing device includes a liquid storage assembly, an air path assembly, the above-mentioned atomizing core, and a power supply assembly.

The liquid storage assembly has a liquid storage cavity inside.

The air path assembly is disposed in the liquid storage cavity and provided with an air channel and a liquid inlet hole connecting the air channel and the liquid storage cavity.

The above-mentioned atomizing core is disposed at a position in the air channel corresponding to the liquid inlet hole, and a circumferential surface of the atomizing base of the atomizing core is in contact with an atomizing medium in the liquid storage cavity via the liquid inlet hole;

The power supply assembly is electrically connected to the atomizing core and configured to enable the heating member of the atomizing core to convert electric energy into thermal energy, so as to heat and atomize the atomizing medium into an aerosol.

In this application, the atomizing passage is designed to have two shapes. The upstream part is square, and the downstream part is circular, elliptical or racetrack, such that the aerosol can be converged through the circular or elliptical hole of the downstream part and then transmitted to the mouth of the user, so that the aroma can be more intense. Further, the atomizing passage is designed to have two shapes, and a step-liked surface is formed at a joint of passages of the two shapes, so that the atomizing medium or the condensate can be effectively prevented from splashing, and the step-liked surface can block the atomizing medium or the condensate. Further, the heating member is disposed along the circumferential direction of the atomizing passage and covers more than ½ of the atomizing passage in the circumferential direction, so that in the square atomizing passage, more than two inner walls are covered with the heating member. In this way, a liquid guiding path becomes longer, and the atomizing core is less prone to accumulation and leakage, thereby effectively solving the problem that the atomizing passage is easy to be blocked and cannot work and the problem that the atomized-liquid flow passage is blocked and generate a smell of burning.

### BRIEF DESCRIPTION OF DRAWINGS

To describe the technical solutions in the embodiments of the disclosure more clearly, the following briefly introduces the accompanying drawings required for describing the embodiments or the exemplary technologies. Apparently, the accompanying drawings in the following description show merely some embodiments of the disclosure, and a person of ordinary skill in the art may still derive other drawings from these accompanying drawings without creative efforts.

FIG. 1 illustrates a schematic diagram of an existing columnar atomizing core.

FIG. 2 illustrates a schematic diagram of an existing planar structural atomizing core.

FIG. 3 illustrates an overall schematic diagram of an atomizing core of the disclosure.

FIG. 4 illustrates a sectional view of an atomizing core of the disclosure along an atomizing passage.

FIG. 5 illustrates an interior view of an atomizing core along an air inlet of an atomizing passage of the disclosure.

FIG. 6 illustrates a schematic diagram of liquid inlet and a thermal field of an atomizing core of the disclosure.

FIG. 7 illustrates an overall schematic diagram of a heating member of an atomizing core of the disclosure.

FIG. 8 illustrates a development view of the heating member of the atomizing core of the disclosure.

FIG. 9 illustrates a schematic assembly diagram of a heating member and an atomizing base of an atomizing core of the disclosure.

FIG. 10 illustrates a schematic diagram where the second atomizing passage is elliptical in the disclosure.

FIG. 11 illustrates a schematic diagram where the second atomizing passage is race-track shaped in the disclosure.

FIG. 12 illustrates a schematic diagram where the second atomizing passage is rectangular in the disclosure.

Explanation of reference numerals in the drawings:
100—atomizing base;
110—second atomizing passage;
120—first atomizing passage;
200—heating member;
210—fixing portion;
220—electrode; and
230—electrode pin.

### DETAILED DESCRIPTION

To make the objectives, technical solutions, and advantages of the disclosure clearer, the following further describes the disclosure in detail with reference to the accompanying drawings and embodiments. It should be understood that the embodiments described herein are only intended to explain the disclosure, but not to limit the disclosure.

Note that when a component is referred to as being “fixed to” or “disposed on” another component, it may be directly on or indirectly on the other component. When a component is referred to as being “connected” to another component, it may be directly or indirectly connected to the other component. The orientation or position relationship indicated by the terms “up,” “down,” “left,” “right,” etc. is based on the orientation or position relationship shown in the drawings. These above terms are only for convenience of description rather than indicating or implying that the device or element referred to must have a particular orientation or be constructed and operated in a particular orientation, and should not be construed as any limitation to the disclosure and a person of ordinary skill in the art may understand the specific meaning of the above terms according to specific situations. The terms “first” and “second” are only used for ease of description, and should not be understood as indicating or implying relative importance or implicitly indicating the number of technical features. “Multiple” means two or more than two, unless specified otherwise.

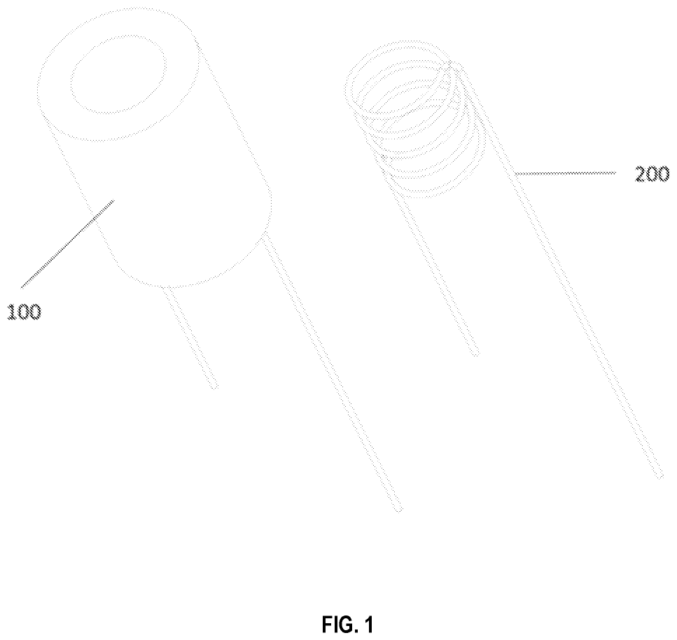

FIG. 1 illustrates a schematic diagram of an existing columnar atomizing core.

In a traditional atomizing core, as shown in FIG. 1, a spring heating wire of a columnar ceramic atomizing core has a very small diameter, and is prone to coiling and deforming during production, resulting in a smell of burning, a small atomizing amount, or a slow initial atomizing. The degree to which the spring heating wire exposes the ceramic heating surface is unstable and is prone to being lower or higher than the ceramic heating surface, resulting in a small atomizing amount or a smell of burning. The exposed metal surface of the spring heating wire is small, resulting in a small atomizing amount. Further, the service life of the cylindrical ceramic atomizing core is short. Due to the distribution of the spring heating wire, the high-temperature area is too concentrated and the surface of the heating wire tends to have deposit carbon deposition, resulting in taste fading, taste change, smell of burning, color change of an atomized liquid, etc., and the service life thereof also becomes shorter. Furthermore, the cylindrical ceramic atomizing core is cylindrical in both interior and exterior, and the cylindrical porous ceramic has a uniform wall thickness, but the thickness of the wall at the position directly facing the atomized liquid hole is small, which easily causes accumulation and leakage of the atomized liquid. Additionally, due to the surface tension of the atomized liquid, the center circular atomizing passage is prone to be blocked due to accumulation and leakage of atomized liquid.

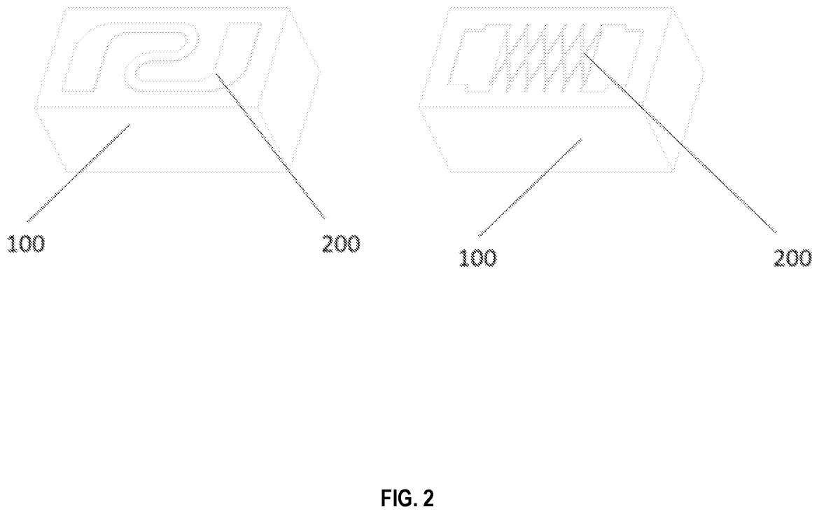

FIG. 2 illustrates a schematic diagram of an existing planar structural atomizing core.

As shown in FIG. 2, when using the planar ceramic atomizing core, an air channel must be designed as a deflected air channel, and condensate in the air channel tends to accumulate and block. Furthermore, the planar ceramic atomizing core directly introduces the atomized liquid towards the back side of the porous ceramic, when the atomized liquid is sticky, bubbles are difficult to rise and can easily block the atomized-liquid flowing channel, causing the atomized liquid to flow unsmoothly and thus resulting in dry burning as well as a smell of burning. The planar ceramic atomizing core has a relatively large size, and the product cannot be ultra-thin. The ceramic resistance value is difficult to adjust, and the manufacturing cost is high.

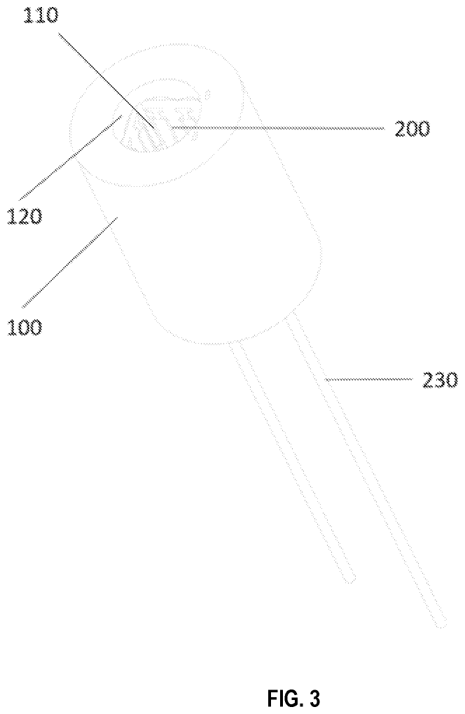

FIG. 3 illustrates an overall schematic diagram of an atomizing core of the disclosure.

In view of this, as shown in FIG. 3, the disclosure provides an atomizing core. The atomizing core includes an atomizing base 100 and a heating member 200. The atomizing base 100 is in contact with an atomizing medium and configured to absorb the atomizing medium, and guide the atomizing medium to the heating member 200. The heating member 200 is configured to heat and atomize the atomizing medium. In this embodiment, the material of the atomizing base 100 may be porous ceramic, foam ceramic, or other porous material having a strong adsorption force and enough cavities. In this way, more atomizing medium can be adsorbed, and furthermore, atomizing is more sufficient since a cavity is provided. The atomizing base 100 has an atomizing passage in the interior of the atomizing base 100. An air inlet and an air outlet of the atomizing passage are respectively in communication with two end-faces of the atomizing base 100, forming a through hole in the interior of the atomizing base 100, and aerosols generated by atomizing of the heating member are inhaled into the mouth of a user through the atomizing passage.

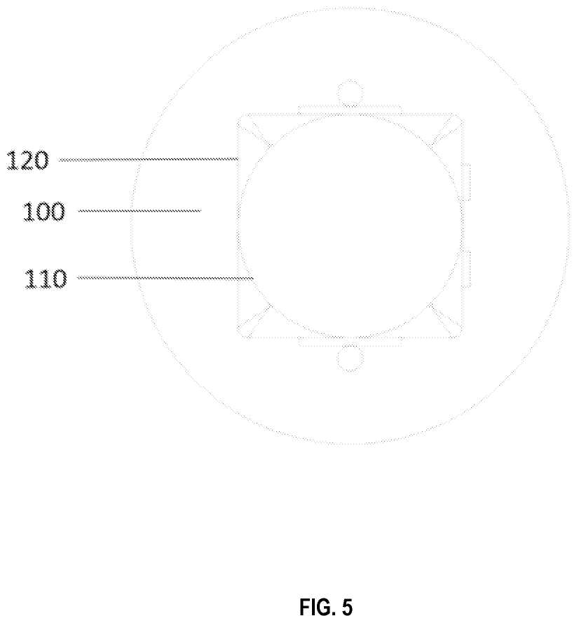

FIG. 5 illustrates an interior view of an atomizing core along an air inlet of an atomizing passage of the disclosure.

As shown in FIG. 5, in this embodiment, a cross section of the atomizing passage perpendicular to an extending direction of the atomizing passage has at least two different shapes, thus defining a first atomizing passage 120 and a second atomizing passage 110. That is, the cross section of the first atomizing passage 120 perpendicular to the extending direction of the first atomizing passage 120 and the cross section of the second atomizing passage 110 perpendicular to the extending direction of the second atomizing passage 110 have two different shapes, and an area of the cross section of the second atomizing passage 110 perpendicular to the extending direction of the second atomizing passage 110 is less than an area of the cross section of the first atomizing passage 120 perpendicular to the extending direction of the first atomizing passage 120. An air outlet of the first atomizing passage 120 is connected to an air inlet of the second atomizing passage 110, and a step-liked surface is formed at a position where the first atomizing passage 120 is connected to the second atomizing passage 110, thus the atomizing medium and the condensate can be effectively prevented from splashing.

In this embodiment, the cross section of the first atomizing passage 120 perpendicular to the extending direction of the first atomizing passage 120 is square. The cross section of the second atomizing passage 110 perpendicular to the extending direction of the second atomizing passage 110 is circular, and the area of the cross section of the second atomizing passage 110 perpendicular to the extending direction of the second atomizing passage 110 is smaller than the area of the cross section of the first atomizing passage 120 perpendicular to the extending direction of the first atomizing passage 120, such that the aerosol can be gathered effectively through the second atomizing passage 110, making the aerosol more rich.

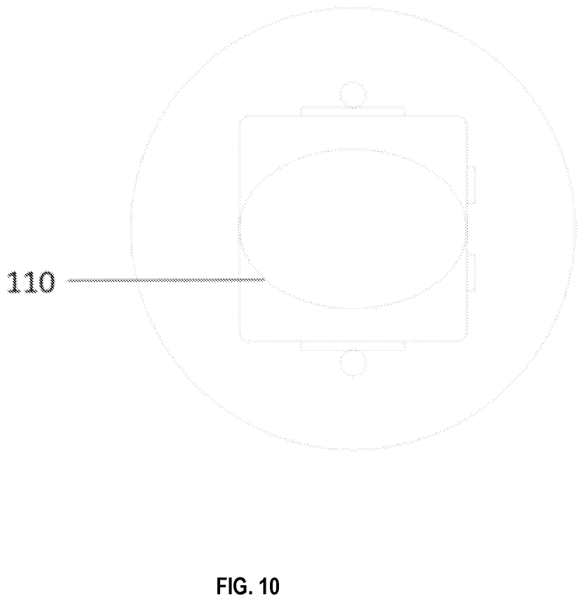

FIG. 10 illustrates a schematic diagram where the second atomizing passage is elliptical in the disclosure.

As shown in FIG. 10, in another embodiment, the cross section of the first atomizing passage 120 perpendicular to the extending direction of the first atomizing passage 120 is square. The cross section of the second atomizing passage 110 perpendicular to the extending direction of the second atomizing passage 110 is elliptical, and the area of the cross section of the second atomizing passage 110 perpendicular to the extending direction of the second atomizing passage 110 is smaller than the area of the cross section of the first atomizing passage 120 perpendicular to the extending direction of the first atomizing passage 120.

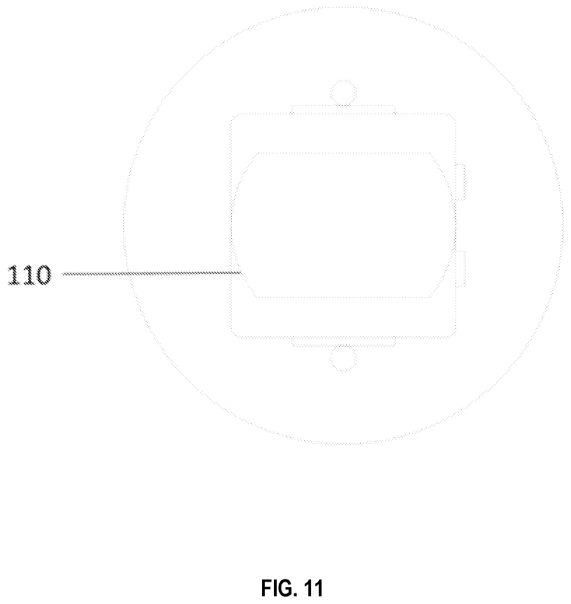

FIG. 11 illustrates a schematic diagram where the second atomizing passage is race-track shaped in the disclosure.

As shown in FIG. 11, in another embodiment, the cross section of the first atomizing passage 120 perpendicular to the extending direction of the first atomizing passage 120 is square. The cross section of the second atomizing passage 110 perpendicular to the extending direction of the second atomizing passage 110 is race-track shaped, and the area of the cross section of the second atomizing passage 110 perpendicular to the extending direction of the second atomizing passage 110 is smaller than the area of the cross section of the first atomizing passage 120 perpendicular to the extending direction of the first atomizing passage 120.

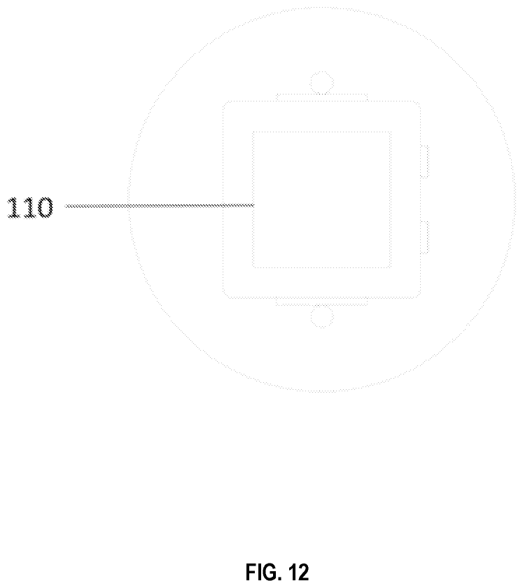

FIG. 12 illustrates a schematic diagram where the second atomizing passage is rectangular in the disclosure.

As shown in FIG. 12, in another embodiment, the cross section of the first atomizing passage 120 perpendicular to the extending direction of the first atomizing passage 120 is square. The cross section of the second atomizing passage 110 perpendicular to the extending direction of the second atomizing passage 110 is also square, and the area of the cross section of the second atomizing passage 110 perpendicular to the extending direction of the second atomizing passage 110 is smaller than the area of the cross section of the first atomizing passage 120 perpendicular to the extending direction of the first atomizing passage 120.

In this embodiment, the second atomizing passage 110 is configured such that the area of the cross section of the second atomizing passage 110 perpendicular to the extending direction of the second atomizing passage 110 gradually decreases along the airflow inhalation direction. In this way, the shape of the second atomizing passage 110 can be limited, thereby limiting the airflow inhalation direction and making the aerosol gather better.

The end face of the air inlet of the second atomizing channel 110 is arranged to partially cover the air outlet of the first atomizing channel 120, such that a step-liked surface is formed at the joint of the first atomizing passage 120 and the second atomizing passage 110. When the aerosol enters the second atomizing channel 110 from the first atomizing channel 120, the aerosol is partially blocked by the fracture surface of the air inlet of the second atomizing channel 110, so that the atomizing medium or condensate can be effectively prevented from splashing during the inhalation of the aerosol.

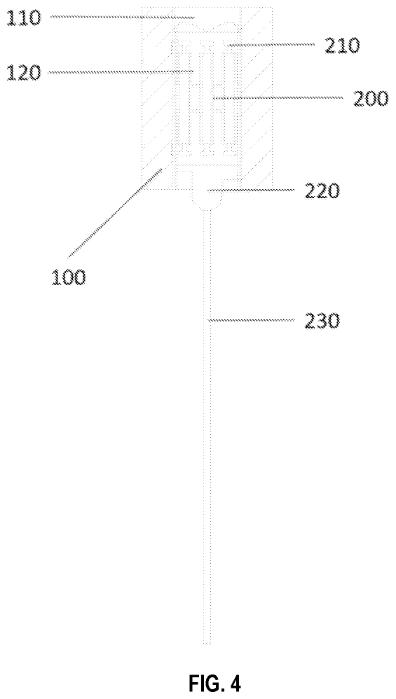

FIG. 4 illustrates a sectional view of an atomizing core of the disclosure along an atomizing passage.

As shown in FIG. 4, the heating member 200 is arranged along the circumferential direction of the atomizing passage. In this embodiment, the heating member 200 is disposed in the first atomizing passage 120 and arranged along the circumferential direction of the first atomizing passage 120. The first atomizing passage 120 is a square-shaped passage structure composed of four plane inner walls perpendicular to one another. The heating member 200 is arranged in close contact with the inner wall of the first atomizing passage 120, and an inner surface of the heating member 200 exposes the surface of the atomizing base 100. When the atomized medium is heated and atomized, it is less likely to have a smell of burning and will have a larger atomizing amount, and the surface of the heating member is not prone to carbon deposition. Aerosol has less attenuation of aroma intensity, odor attenuation, and flavor change.

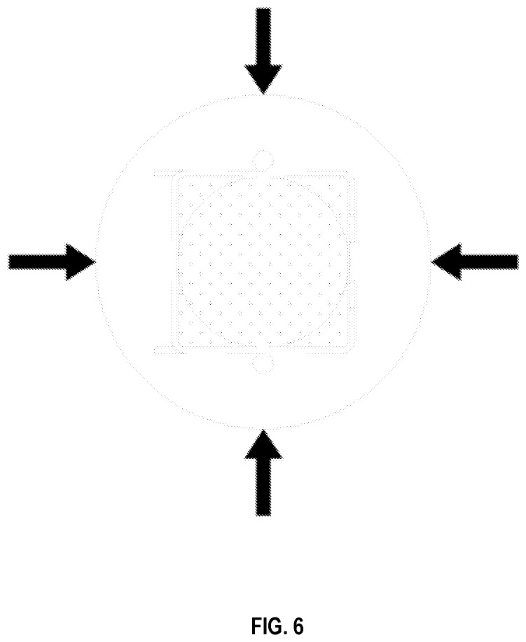

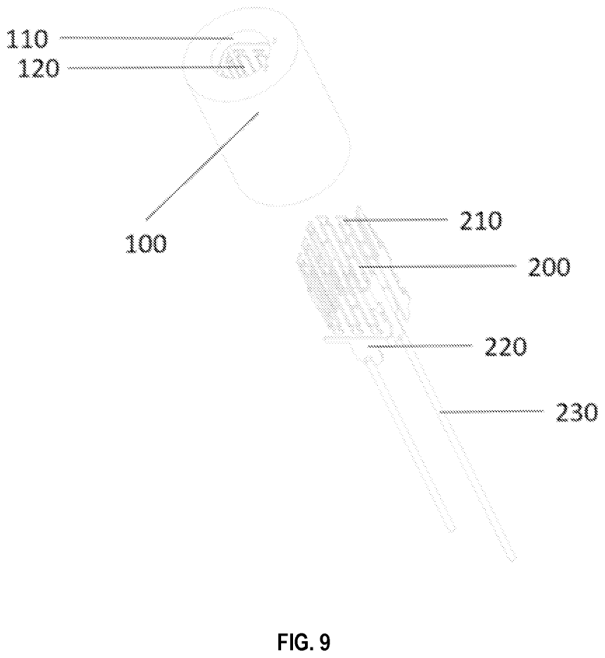

FIG. 6 illustrates a schematic diagram of liquid inlet and a thermal field of an atomizing core of the disclosure. FIG. 9 illustrates a schematic assembly diagram of a heating member and an atomizing base of an atomizing core of the disclosure.

The heating member 200 is arranged along the circumferential direction of the first atomizing passage 120, and at least covers more than ½ of the first atomizing passage 120 in the circumferential direction. As shown in FIG. 9, in this embodiment, the heating member 200 is a heating mesh and includes multiple heating units. The heating member 200 is arranged on four inner walls of the first atomizing passage 120 along the circumferential direction of the first atomizing passage 120. Furthermore, the heating units are connected in series, so that the heating member 200 can simultaneously generate heat on four inner walls of the first atomizing passage 120. As shown in FIG. 6, heat is generated on four sides, so that the thermal field in the first atomizing passage 120 is more uniform.

As shown in FIG. 6, in this embodiment, the heating member 200 is arranged on four inner walls of the first atomizing passage 120, and thus the four inner walls of the first atomizing passage 120 are atomizing surfaces. The circumferential surface of the atomizing base 100 is a liquid-absorbing surface. In the arrow direction, the atomizing medium enters the atomizing base 100 from the liquid-absorbing surface, and the atomizing medium is guided to the atomizing surface through the atomizing base 100, i. e., the inner wall of the first atomizing passage 120, for the heating member 200 to heat and atomize the atomizing medium into an aerosol. Since the shape of the cross section of the first atomizing passage 120 perpendicular to the extending direction of the first atomizing passage 120 is different from the shape of the circumferential surface of the atomizing base 100, specifically, in this embodiment, the cross section of the first atomizing passage 120 perpendicular to the extending direction of the first atomizing passage 120 is square, and the circumferential surface of the atomizing base 100 is cylindrical, and thus the wall thickness of the atomizing base 100 from the liquid-absorbing surface to the atomizing surface is not equal. In this way, for different liquid inlet holes on the liquid suction surface, the liquid guiding paths from the liquid inlet hole to the atomizing surface are different, as such, the atomizing medium can be effectively prevented from accumulation, leakage, and blocking the atomizing passage.

In this embodiment, multiple liquid inlet channels are distributed on the liquid-absorbing surface, and the liquid inlet direction of each liquid inlet channel is perpendicular to the inner wall of the first atomizing channel 120. Accordingly, the liquid guiding paths of the liquid inlet channels corresponding to different positions along the inner wall of the first atomizing channel 120 are different, and the liquid guiding path of the liquid inlet channel corresponding to the midpoint position of the inner wall of the first atomizing channel 120 is the longest. By providing the liquid inlet channels with different liquid guiding paths, accumulation and leakage at the atomizing base 100 can be effectively prevented. At the same time, because of the influence of the surface tension of the atomizing medium, the four corners and the central position of the inner walls of the first atomizing channel 120 are not prone to not working due to blockage of holes and not prone to generating a smell of burning due to blockage of the atomized-liquid flowing channel, unless there is a large volume of liquid accumulation and leakage.

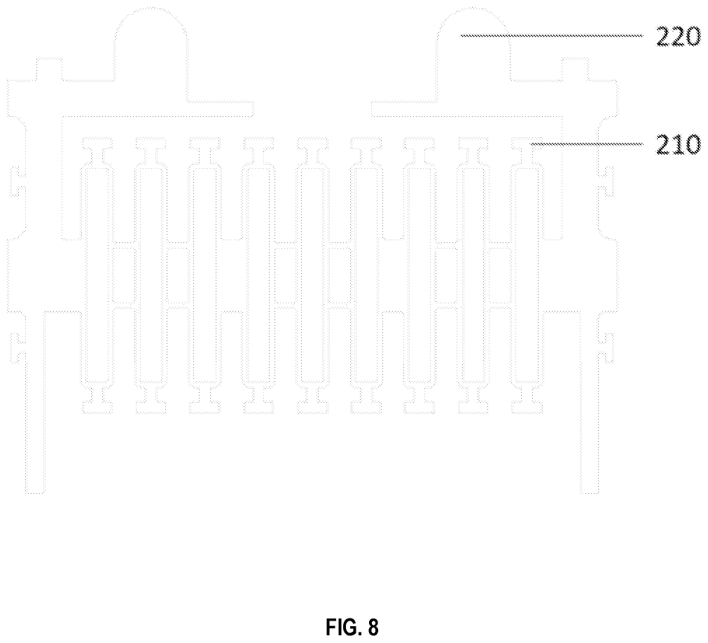

FIG. 8 illustrates a development view of the heating member of the atomizing core of the disclosure.

As shown in FIG. 8, in this embodiment, the heating member 200 is a heating mesh including multiple heating units. The multiple heating units are connected in series, and each heating unit extends in an axial direction of the first atomizing passage 120 and is arranged in a circumferential direction of the first atomizing passage 120. Each heating unit is provided with a fixing portion 210 at each of two ends of the first atomizing passage 120 extending in the axial direction. The fixing portion 210 may be in various shapes such as a “T” shape, an “H” shape, an “L” shape, and an “I” shape. The fixing portion 210 may be inserted into the atomizing base 100 in an overturned and curved manner, so that the heating member 200 can be better fixed to an inner wall of the first atomizing passage 120, and delamination and uplift will not occur.

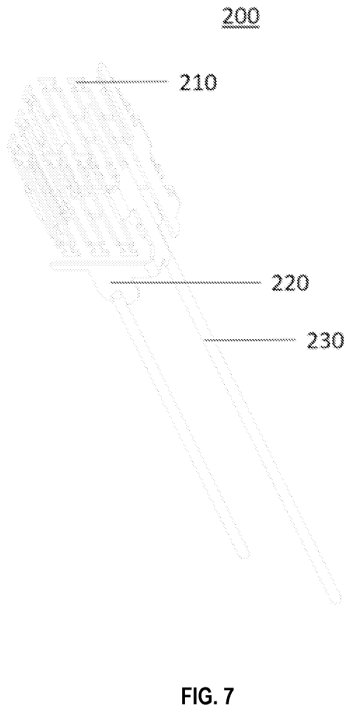

FIG. 7 illustrates an overall schematic diagram of a heating member of an atomizing core of the disclosure.

As shown in FIGS. 7 and 8, two sides of the heating member 200 are extended and provided with electrode plates 220, and the electrode plates 220 are connected to the power supply assembly through the electrode pins 230. The heating member 200 is bent along connection portions between multiple heating units and enclosed to form a square heating member structure corresponding to the first atomizing passage 120. As shown in FIG. 9, the heating member 200 is disposed in the first atomizing passage 120 and is closely attached to an inner wall of the first atomizing passage 120. After bending and enclosing of the heating member 200, the electrode sheet 220 is located on two opposite inner walls of the first atomizing passage 120. Correspondingly, the electrode pins 230 are also led out from two opposite inner walls of the first atomizing passage 120, so that the spacing between the two electrode pins 230 is relatively large, and the two electrode pins 230 are less likely to form a short circuit due to contact each other during assembly.

In this embodiment, for the heating member 200, a planar metal heating mesh is molded and shaped, and then a pin is welded to form a complete heating member 200. Thereafter, the heating member 200 is combined with the atomizing base 100 by means of slip casting and sintering, thereby completing the manufacture of the atomizing core.

Embodiments further provide an atomizing device. The atomizing device includes: a liquid storage assembly having a liquid storage cavity, where the liquid storage cavity is filled with an atomizing medium; an air path assembly disposed in the liquid storage cavity, where the air path assembly is provided with an air channel and a liquid inlet hole connecting the air channel and the liquid storage cavity; the above-mentioned atomizing core, where: the atomizing passage of the atomizing core is in communication with the air channel of the air path assembly, the atomizing core is disposed at a position in the air channel corresponding to the liquid inlet hole, the circumferential surface of the atomizing base 100 of the atomizing core is in contact with the atomizing medium in the liquid storage cavity via the liquid inlet hole, and the atomizing medium enters the air channel via the liquid inlet hole, so as to be absorbed by the atomizing core; a power supply assembly electrically connected to the atomizing core and configured to enable the heating member of the atomizing core to convert electric energy into thermal energy, so as to heat and atomize the atomizing medium into an aerosol.

The foregoing descriptions are merely exemplary embodiments of the disclosure, and are not intended to limit the disclosure. For those skilled in the art, the disclosure may have various modifications and variations. Any modifications, equivalent replacements, improvements and the like made within the spirit and principle of the disclosure shall belong to the scope of the claims of the disclosure.

What is claimed is:

1. An atomizing core, comprising:
an atomizing base, configured to be in contact with an atomizing medium, wherein the atomizing base is provided with an atomizing passage inside, an air inlet and an air outlet of the atomizing passage are respectively in communication with two end faces of the atomizing base, and a cross section of the atomizing passage perpendicular to an extending direction of the atomizing passage has at least two shapes; and
a heating member, disposed in the atomizing passage, wherein the heating member is arranged in a circumferential direction of the atomizing passage, and the heating member at least covers more than half of the atomizing passage in the circumferential direction.

2. The atomizing core according to claim 1, wherein the atomizing passage comprises, along an airflow inhalation direction, a first atomizing passage and a second atomizing passage, and an area of a cross section of the second atomizing passage perpendicular to the extending direction of the second atomizing passage is smaller than an area of a cross section of the first atomizing passage perpendicular to the extending direction of the first atomizing passage.

3. The atomizing core according to claim 2, wherein the cross section of the first atomizing passage perpendicular to the extending direction of the first atomizing passage is square, and the cross section of the second atomizing passage perpendicular to the extending direction of the second atomizing passage is any one of circle, ellipse, race-track shaped, or rectangle.

4. The atomizing core according to claim 2, wherein, along the airflow inhalation direction, the area of the cross section of the second atomizing passage perpendicular to the extending direction of the second atomizing passage gradually decreases.

5. The atomizing core according to claim 2, wherein: an inner wall of the first atomizing passage is an atomizing surface, a circumferential surface of the atomizing base is a liquid-absorbing surface, a distance from the liquid-absorbing surface to the atomizing surface is a wall thickness of the atomizing base, and the wall thickness of the atomizing base is at least partially unequal.

6. The atomizing core according to claim 2, wherein an end-face portion of an air inlet of the second atomizing passage covers an air outlet of the first atomizing passage.

7. The atomizing core according to claim 2, wherein the heating member is disposed in the first atomizing passage, the first atomizing passage comprises four inner walls arranged in sequence and perpendicular to one another, and the heating member at least covers three inner walls of the first atomizing passage.

8. The atomizing core according to claim 5, wherein a plurality of liquid inlet channels are arranged on the liquid-absorbing surface, and a liquid inlet direction of each of the liquid inlet channels is perpendicular to the inner wall of the first atomizing passage.

9. The atomizing core according to claim 7, wherein the heating member comprises two electrode pins, and the two electrode pins are disposed on two opposite inner walls of the first atomizing passage.

10. The atomizing core according to claim 1, wherein the heating member comprises a plurality of heating units connected in series, and each of the heating units is provided with a fixing portion which is attached and parallel to an inner wall of the atomizing passage and extends along the atomizing base.

11. An atomizing device, comprising:
a liquid storage assembly, provided with a liquid storage cavity inside;
an air path assembly, disposed in the liquid storage cavity and provided with an air channel and a liquid inlet hole connected to the air channel and the liquid storage cavity;
an atomizing core, disposed at a position in the air channel corresponding to the liquid inlet hole, wherein the atomizing core comprises:
an atomizing base, configured to be in contact with an atomizing medium, wherein the atomizing base is provided with an atomizing passage inside, wherein an air inlet and an air outlet of the atomizing passage are respectively in communication with two end faces of the atomizing base, wherein a cross section of the atomizing passage perpendicular to an extending direction of the atomizing passage has at least two shapes, and wherein a circumferential surface of the atomizing base of the atomizing core is in contact with an atomizing medium in the liquid storage cavity via the liquid inlet hole;
a heating member, disposed in the atomizing passage, wherein the heating member is arranged in a circumferential direction of the atomizing passage, and the heating member at least covers more than half of the atomizing passage in the circumferential direction; and
a power supply assembly electrically connected to the atomizing core and configured to enable the heating member of the atomizing core to convert electric energy into thermal energy in order to heat and atomize the atomizing medium into an aerosol.
